(19) United States
(12) Patent Application Publication
(10) Pub. No.: US 2002/0069312 A1
(43) Pub. Date: Jun. 6, 2002

(54) System and method for the storage, management and sharing of spatial-temporal based information

(76) Inventor: Gad Quentin Jones, Morristown, NJ (US)

Correspondence Address: Samuel H. Dworetsky, AT&T CORP., P.O. Box 4110, Middletown, NJ, 07748-4110, US

(21) Appl. No.: 09/898,190

(22) Filed: Jul. 3, 2001

Related U.S. Application Data
(60) Provisional application No. 60/217,089, filed on Jul. 10, 2000.

(51) Int. Cl. G06F 13/28

(52) U.S. Cl. 711/100

(57) ABSTRACT

A personal, group, and community spatial-temporal based information system for the storage, management and sharing of user annotated spatial-temporal based information is disclosed. Spatial-temporal information is provided to the system by a variety of remote users. Geographical coordinates and time are automatically stored or sent by the device to a spatial-temporal sub-system which includes a spatial-temporal information database and a geographical information system database. Users can easily add highly accurate and relevant spatial-temporal information into a personal information management system, to be stored, shared, edited and managed by the user.

This application claims the benefit of U.S. Provisional Application Ser. No. 60/217,089 filed Jul. 10, 2000, which is hereby expressly incorporated by reference as if fully disclosed herein.

### BACKGROUND OF THE INVENTION

The present invention relates to systems and methods for the storage, management, and sharing of spatial-temporal based information, and more particularly to a system and method for the storage, management, and sharing of spatial-temporal based information markers having user annotated portions.

The exponential growth in wireless networking and wireless Internet services has led to the creation of a variety of new products, services and markets. A number of these have involved the use of various geographic information systems (GIS), cell broadcast based positioning based services, LAN/WAN/Bluetooth/Infrared based positioning tools/devices, and Global Positioning Systems (GPS). For example, mobile phone networks can now be used to detect a subscriber's location by triangulating different cell connections to the phone. This enables vendors to offer location-specific services such as advice on nearby shops and restaurants or directions to the nearest petrol station. With the establishment of cellular location-based services (LBS) infrastructure, a variety of widely available LBS's have been and are being developed. However, to date, services using these technologies have been limited to applications such as fleet or automatic vehicle location, telematics (machine to machine communication), consumer applications focused on personal safety and emergency assistance, and position sensitive services directed to consumer advertising or information retrieval such as directional advice. Personal and community geographical position and time data has not yet been made available as a valuable daily personal information resource for the general public.

Accordingly, it would be desirable to have a system and method which combines the capabilities of existing location and time detection technology, wireless access technologies and the Internet in one seamless integration so as to allow users to intuitively and easily provide, access and share spatial-temporal information collected from a variety of locations and destinations.

### SUMMARY OF THE INVENTION

The present invention is a system and method for receiving, storing and providing access to a collection of spatial-temporal information entries collected from a variety of locations as supplied by a multitude of remote users. The spatial-temporal information entries are essentially geographical bookmarks or “Geomarks” which include a user identification component, a location component, a date/time component and some descriptive annotated information provided by the user. The present invention allows individuals and groups to maintain a record of the places they have visited via the management of Geomarks. Users of the system are also able to categorize locations along a number of dimensions that may be shared with other users of the system. The Web site allows people to find information about other users that have visited a specified geographical location, and their ratings and or comments about the place. The system also enables individuals to supplement their Geomarks with descriptive annotations, including the ability to annotate with sound or voice based annotations.

In one embodiment of the present invention, the invention is a method for providing distributed user access of spatial-temporal based information which includes the steps of receiving a plurality of spatial-temporal based information entries from a plurality of users utilizing geographic positioning compatible devices, storing the plurality of spatial-temporal based information entries from the plurality of users and providing access to the plurality of stored spatial-temporal based information entries, wherein each spatial-temporal based information entry identifies at least one location, a date/time the at least one location was visited and some user annotated information related to the at least one location.

In another embodiment of the present invention, the invention is a spatial-temporal based information system which includes a global positioning component, a geographical information component and at least one spatial-temporal component for receiving and storing spatial-temporal information in concert with information received from the global positioning component and the geographical information component, wherein the at least one spatial-temporal component includes a database operative to receive, store and provide access to a plurality of user provided spatial-temporal bookmarks which identify particular locations and descriptive annotated information related to the particular locations, the at least one spatial-temporal component accessible from a plurality of remote locations.

In yet another embodiment of the present invention, the invention is an apparatus communicatively coupling a plurality of clients to a spatial-temporal based information system which includes a storage device, operative to store and retrieve spatial-temporal based information on demand and a controller, coupled to the storage device, operative to receive spatial-temporal based information from the plurality of clients and on behalf of and in response to client requests, to provide the requesting clients with the received spatial-temporal based information.

### BRIEF DESCRIPTION OF THE DRAWINGS

FIG. 1 illustrates an exemplary system of the present invention.

FIG. 2 illustrates another exemplary system of the present invention.

FIG. 3 illustrates an exemplary method of the present invention.

FIG. 4 illustrates another exemplary method of the present invention.

FIG. 5 illustrates an exemplary spatial-temporal based information entry of the present invention.

### DETAILED DESCRIPTION OF THE INVENTION

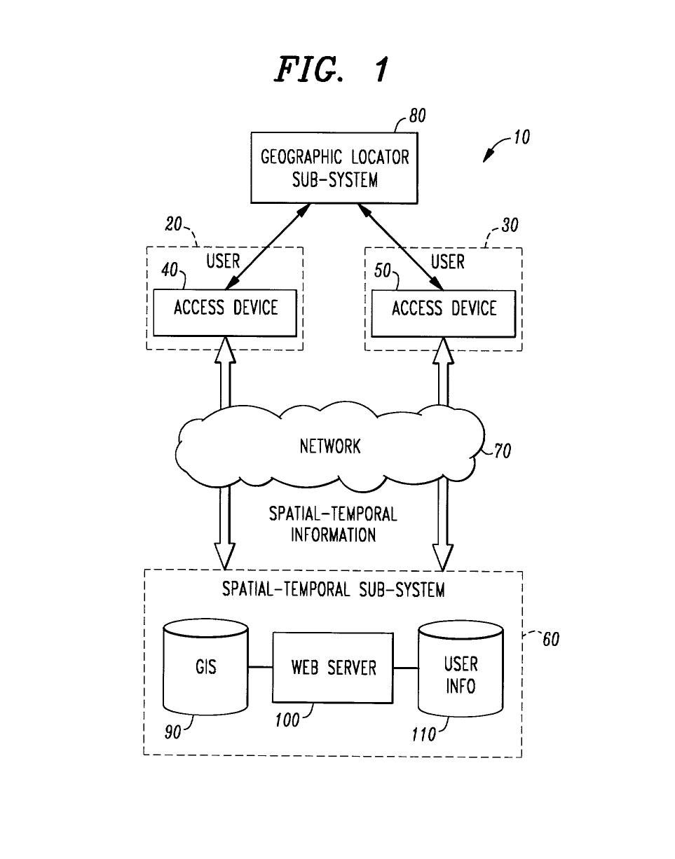

Referring to FIG. 1, a system 10 for the storage, management, and sharing of spatial-temporal based information is shown. As used herein, the term “spatial-temporal” refers to user information entries or “geographical bookmarks” (Geomarks). These Geomarks contain information related to specific locations, areas, places, localities, regions, destinations and sites as provided by users in conjunction with one or more location and date/time determination systems. In the present invention, these Geomarks are received from a variety of user remote electronic devices including laptops, mobile phones, personal digital assistants (PDAs), handhelds, PCs, pagers and other communicative devices which allow individuals, groups and communities to maintain and access historical records of the locations, areas, destination and sites they have visited. In the present invention, the spatial-temporal information collected from a user may be based on a location as a specific as a store in a specific town or as general as a geographic region, depending on the preferences of the user. As used herein, the term “user” may refer to an individual user, or may be used interchangeably to refer collectively to a group of users or a community of users.

In the present invention, a multitude of spatial-temporal based information entries with corresponding user annotations are received and collected from a multitude of users. As used herein, the term “annotated” or “annotation” refers to one or more supplementary pieces of user supplied information which accompanies a user's spatial-temporal information entry or Geomark. For example, the annotations may be recorded audible annotations of a fixed length which is used to supplement a specific user spatial-temporal information entry or Geomark. An audible annotation can include any type of audible information, including, but not limited to, the user's own vocal expressions, music, atmospheric or environmental noise, computer generated sound, etc. User annotation can also take the form of supplementary text, images, links or other mechanisms for enhancing a spatial-temporal entry provided by the user.

Referring again to FIG. 1, in one exemplary basic configuration, system 10 includes one or more users 20, 30 utilizing one or more access devices 40, 50 which are in communication with a spatial temporal sub-system 60, which is accessible via a distributed information network 70, such as the Internet. In the present invention, the access devices may be selected from any variety of communication device such as wireless phones, PDAs (Personal Digital Assistants), pagers, laptops, handhelds, PCs, etc. Although only two exemplary users and their respective devices are illustrated in FIG. 1, it is contemplated that only one user or more than two users may have access to system 10 at any one time. It is also contemplated that multiple users may share a single device, or a single user may have multiple devices. Preferably, the system is made available to a multitude of users such that the system benefits from an ever-increasing number of spatial-temporal based information entries from the users. Referring again to FIG. 1, in the present invention, access devices 40, 50 are location or geographic positioning enabled devices which are also in communication with a geographic locator sub-system 80, such as a Global Positioning System (GPS) or other positioning determination system. In the present invention, it is contemplated that a wide variety of technologies and methodologies can be utilized to providing geographical position information on a real-time basis. These may include systems for tracking mobile phone position via cellular cell broadcasts and the use of GPS enabled devices such as PDAs, mobile computers and mobile phones, which typically utilize an existing constellation of satellites that transmit GPS signals that can be used by the GPS enabled device to determine the device's position. As discussed in more detail later herein, one or more users, via their respective access devices, provide annotated spatial-temporal based information to spatial temporal sub-system 60 which is then stored and accessible for future reference. In this exemplary embodiment, spatial-temporal sub-system 60 includes at least one geographical information system (GIS) database 90, at least one Web server 100 and at least one user information database 110. User information database 110 stores the users annotated spatial-temporal information entries.

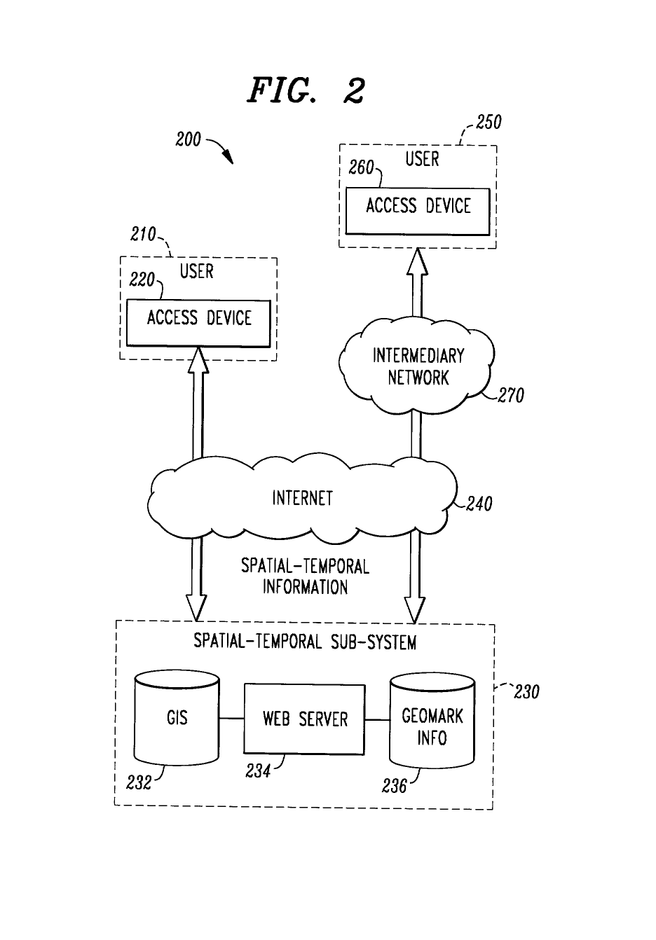

Referring now to FIG. 2, another exemplary system configuration from a user access perspective. As shown, within system 200, a first user 210 utilizes an access device 220 to communicate with a spatial-temporal subsystem 230. As provided earlier herein, spatial-temporal subsystem 230 includes one or more GIS databases or information servers 232, one or more Web servers 234 and one or more storage facilities 236 for storing Geomark information. In this embodiment, it is contemplated that user 210 can connect directly through to a distributed information network, such as the Internet 240 to access spatial-temporal subsystem 230. In this configuration, user 210 can send and receive Geomarks directly to and from spatial-temporal sub-system 230 without any intermediary network.

Referring again to FIG. 2 and referring now to a second user 250 utilizing an access device 260, communication with spatial temporal sub-system 230 involves connection through an intermediary or intermediate network 270 by user 250. Intermediary network 270 may be, for example, a geographically dispersed communication network like a wide area network (WAN), a local area network (LAN) and/or a combination thereof. It is contemplated that the wide area network may be privately owned or rented, but will many times be a combination thereof, with the inclusion of public (shared user) networks within a private network. Intermediary network 270 may also be an intermediate form of network in terms of geography, such as a metropolitan area network (MAN). In another embodiment, intermediary network 270 may be a specialized voice controlled call center, a wireless carrier network, a localized fixed wireless network or other similar network through which communications from user devices may be established with the spatial-temporal sub-system 230.). It also will be evident to one skilled in the art that a connection to a spatial-temporal sub-system 230 shown in FIG. 2 may be established either directly, or through a single or combination of the aforementioned intermediary networks or other similar intermediary network.

In the present invention, communications, such as between user access devices and the spatial-temporal sub-system are enabled by variety of networks, protocols and standards including, but not limited to AMPS, N-AMPS, TDMA, CDMA, GSM, TACS, ESMR, GPRS, Bluetooth, IEEE 802.11, infrared, TCP/IP, SMS and other related networks, protocols and standards. For example, in one embodiment, Short Message Service (“SMS”) may be used in conjunction with, for example, CDMA and/or TDMA to transfer messages from a user's wireless device to a centralized repository, such as provided within spatial-temporal sub-system. In another embodiment, a user may employ a device operating within a wireless LAN as per IEEE 802.11 and such a device may provide a server within the wireless LAN certain Geomarks which are conveyed by the server to the system herein. In yet another embodiment, the present invention may also use Dual Tone Multi-Frequency (“DTMF”) tones to convey user information to the system server. As user herein, the networks described may include base stations, regional stations, central stations and transmitters that are interconnected by landline trunks, base stations, satellites, antennas, routers, bridges and wireless connections.

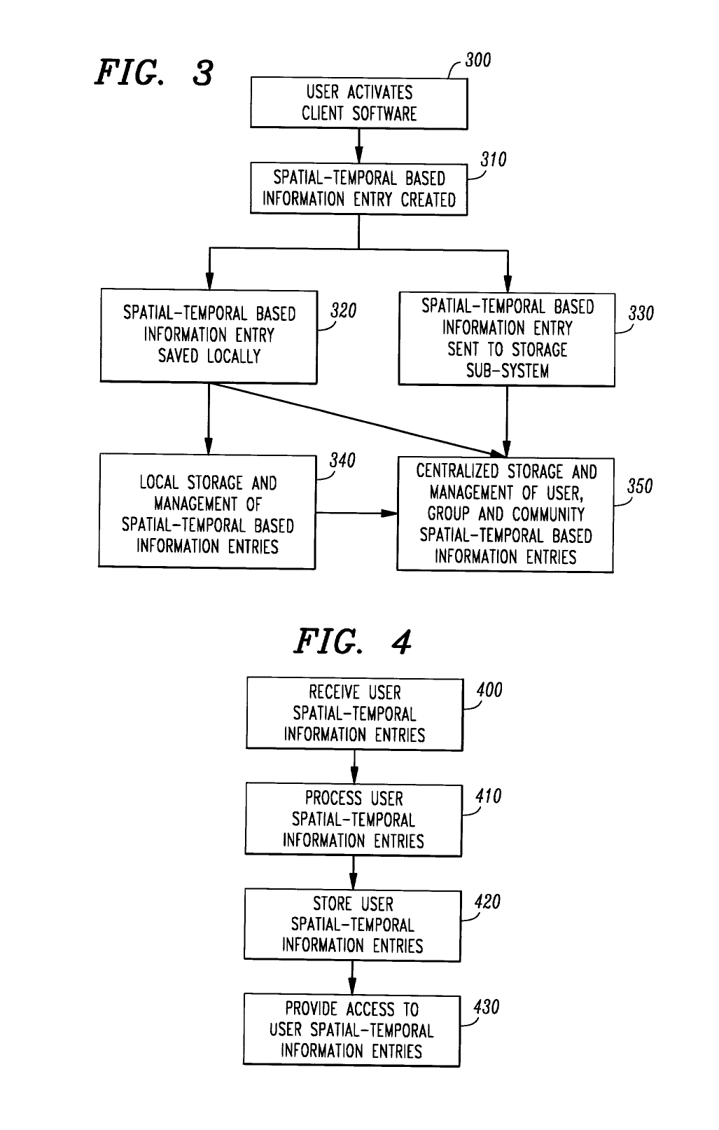

Referring now to FIG. 3, an exemplary method in accordance with the present invention is shown. As shown, typically to begin the geographical bookmarking process, a user activates their client software on their respective access device, step 300. In one embodiment, activating the client software includes steps to establish a connection to the Internet, if such a connection is not already active, by, for example, connecting to an Internet Service Provider (ISP) to gain access to the Geomark system. Once the client software is activated, a spatial-temporal entry is created, step 310. In one embodiment, such an entry is created by having the user record some identifying information about the user's current location, capturing location information based on the user's current location, date/time information based on the current date and time and also having the user provide annotated information as to the location, such as a short voice message. Once the spatial-temporal information entry is created, such information may either be stored locally, step 320 or transferred or communicated to the Geomark system, step 330. It is contemplated that either single or multiple Geomarks may be stored and/or transferred at any one time. For example, it is possible that the user wishes to create a number of Geomarks before transferring them to the centralized Geomark system. Similarly, a number of Geomarks may be also stored on the user's local device and managed locally by the user, step 340. Preferably, the user's Geomarks are eventually provided to a centralized repository for centralized storage, management and eventual access, step 350.

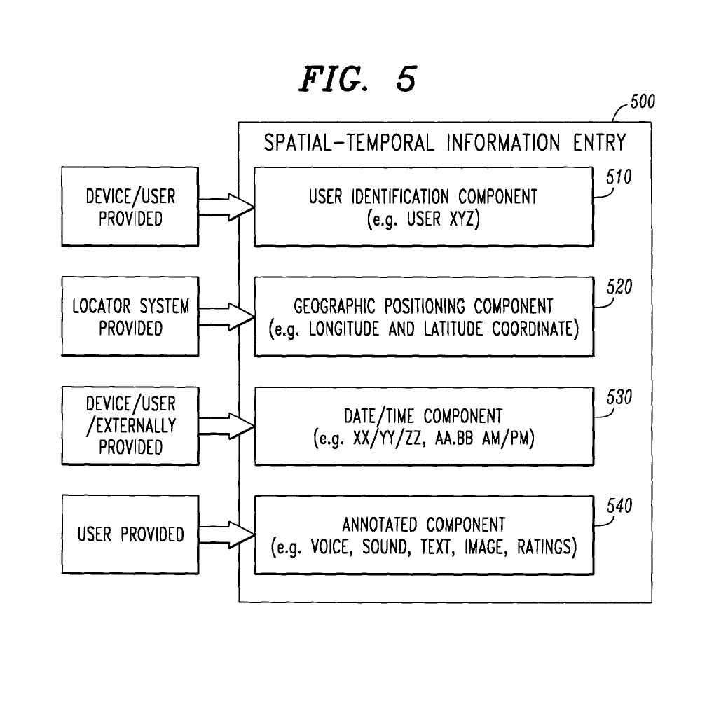

Referring now to FIG. 4, another exemplary embodiment of a method of the present invention is shown. In this embodiment, the present inventive system receives users' spatial-temporal information entries, step 400. At any one time, it is contemplated that tens, hundreds, thousands or more entries may be received from users. Such information is processed, step 410, which can include sorting the entries by any number of relevant sorting categories or filters. For example, entries can be sorted by geographic location, date, time, by certain quality thresholds, by user, etc. so that the entries can be readily accessed subsequent to their submission to the system. Processing may also include formatting the entries into a format suitable for storage and access. Once processed, the users' entries are stored, step 420. Access to the stored entries is provided, step 430, by for example, making the entries accessible via the Web through a system Web page. As discussed in more detail later herein, these entries may be made accessible in a passive manner, such as by publishing the information on a Web site, or alternatively, depending on certain user requirements, the information can be pro-actively provided to users, such as via an messaging facility like electronic mail or instant messaging.

Referring now to FIG. 5, an exemplary spatial-temporary based information entry or Geomark 500 is shown. Preferably, the spatial-temporary based information entry includes one or more of the following components including a user identification component 510, a geographic positioning component 520, a date/time component 530 and an annotated component 540. In one embodiment, the user identification component 510 is provided by the user access device or may be manually provided by the user. The user identification is typically the user's name, login ID or some related alias. Geographic positioning component 520 is typically provided externally by a geographic positioning system which provides or relays the user's access device position to the device and is captured for use in spatial-temporal information entry 500. Date/time component 530 may be provided by either the user's access device, such as by an on-board system calendar/clock, by the user manually or by an external system, such as a GPS system as related to the provision of geographic positioning component 520 discussed above. Annotated component 540 is typically provided by the user directly, such as by having the user provide a voice annotation to accompany spatial-temporal information entry 500.

As discussed herein, other sounds, text, images and even location ratings and categorizations may be provided with the entry by the user. In one exemplary embodiment, it is contemplated that the user's access device will have a mechanism for capturing such annotations, such as a microphone for voice or sound based annotations. Such annotations may then be temporarily stored on the user's local access device, before the user's spatial-temporal information entry is provided to the system along with the corresponding voice or sound annotation.

In the present invention, once the various component have been assembled or collected, such as the user's identification being ascertained, the user's current position, date and time being determined and any user annotations being received, the various components may be encapsulated or packaged and transmitted to, for example, a spatial-temporal sub-system, as illustrated earlier in FIGS. 1 and 2. Encapsulation may be implemented by some sort of electronic wrapper to package the various components together as a single entry. Such packaging may be a simple virtual packaging as it is contemplated that the user's entry may be transmitted in portions or packets.

The present invention will now be discussed with some exemplary system and software configurations and some exemplary user scenarios which are provided only to more fully illustrate the features of the present invention. In one embodiment of the present invention, an exemplary system configuration includes: (1) a user interface, (2) a client server retrieval management system, (3) groupware and virtual community tools, (4) intelligent software agents, (5) a management system for both centralized and distributed management of the spatial-temporal based information, (6) related customized organizational task based sub-systems, (7) virtual tours and (8) a geographically sensitive Web-based search engine, each of which is discussed in more detail following herein.

The present invention provides users with the ability create and access a variety of spatial-temporal based information via a system user interface which may be as simple as interacting through a browser with a user interface provided within a Web page, or a more specialized user interface software may be provided to the user client on their respective access device. Via this user interface, users may create, capture, store and transfer spatial-temporal based information using a variety of devices, preferably with annotations, such as attached text, sound or images, and rankings. For example, a mobile phone user wishing to record a Geomark regarding a shop he has just visited would use a small number of keystrokes or voice commands to let the device know he wished to Geomark the time, place and other details about the relevant shop. The user would then be asked by the device if the user wished to attach voice, text or image to the Geomark and or to provide a rank to the Geomark. At which point the user would provide or specify the desired attachment (e.g. short voice message) and/or rank followed by a simple keystroke or voice command to send the Geomark to the spatial-temporal sub-system or geomemory system to store the Geomark for later transfer to the system. The user identification, date, time and place data would typically automatically be captured via the device using one of a variety of methods as previously described in more detail herein.

The present invention may also include a client-server information retrieval management system. Information, or more specifically, Geomark retrieval is linked to a geographical information system, which automatically displays available relevant information related to individual Geomarks. For example, a user who has stored a Geomark about an area associated with a particular shop would typically when using a browser to retrieve information about that Geomark receive not only geographical and temporal co-ordinates, but also attached material such as pictures, comments and ranks. This same user could retrieve his Geomarks using geographic, temporal, keywords or Boolean search techniques.

Geomark based groupware and virtual community software based tools may be provided to the user to supplement the system user interface. Using these tools, Geomarks can be shared if desired and used to profile places and people. The tools can also be used to build virtual-communities and make place based announcements virtually. For example, this would allow a user to share his restaurant Geomarks rankings, and/or read other users' rankings of the restaurant or other locations/destinations. Related to this, intelligent semi-autonomous software agents may be provided to act for users to receive ‘smart’ recommendations about places based on the Geomarks of other users. A management system for both the centralized and distributed management of Geomarks may also be provided to users. This system would allow a user could choose to store some Geomarks on his client yet still receive related information using the aforementioned Web system when retrieving previous Geomarks. In this configuration, the system would allow for the searching of public Geomark data stored on distributed client devices provided the clients being searched have set the required permissions. In one embodiment, related customized organizational task based geomemory sub-systems may also be provided. Certain organizational Geomarks can be stored using such customized organizational geomemory sub-systems. For example, such a sub-system may be used by security or policing services to allow for the easy capture and management of spatial-temporal surveillance information or the reporting of a crime scene. Geographical, spatial and other information can be displayed as a browser based tour using a collection of Geomark data to guide a virtual tour engine.

Additionally, in one exemplary system configuration, a geographically sensitive Web-based search engine may be provided to allow individual, group and community Geomarks to be searched, retrieved and presented in combination with other relevant propriety and non-propriety geographical information. Such a search engine will also allow the user to search the Internet for geographically sensitive information. The search engine will extract from various Web sites on the Internet material of geographic relevance by accessing data linking place names to geographic co-ordinates. The search engine may also use smart agent technology to retrieve information from Web sites driven by database technology. This will allow users to obtain spatial-temporal information linked to individuals, groups or communities, or places by keywords and/or geographic features. In this manner, user entries and associated annotations may be used to bootstrap the creation of virtual communities around GIS's.

In the present invention, a user's spatial-temporal based information can be provided to the system in a variety of different manners, such as automatically, semi-automatically or manually. Additionally, the information may be sent or a real time basis or stored and provided to the system at a later time as required by the user's system configuration. In one exemplary embodiment, a user's spatial-temporal based information may be collected and then sent on a real time. The information may also be stored locally on the user's access device and downloaded or “pushed” to the system at a later time. In another exemplary embodiment, the information may be provided in a streaming format. For example, in one exemplary scenario, a corporation may constantly track an individual's location, this location data stream can be sent to the geomemory system where the user can then extract relevant Geomarks.

In the present invention, the basic components or subsystems of the spatial-temporal system include a Web based system, a Geomemory System and Client-side and wireless location services devices and software, each of which is discussed in more detail following herein. In one embodiment of the present invention, the Web based system may contain the following exemplary components/options:

1. An explanation of the geomemory via text and or multimedia;

2. Tools, or links to tools for updating personal, group or community Geomark data;

3. Subscription options, or links to subscription options regarding updates to changes in the Geomarks or GIS databases related to a particular spatial-temporal area. These updates can be received via SMS, Web-browsing, wireless Internet, email and voice mail to a mobile phone;

4. Tools, or links for obtaining profiles about a particular spatial-temporal location based on a mixture of GIS and user generated Geomark content;

5. A search engine allowing users to obtain information spatial-temporal information linked to individuals, groups or communities, or places by keywords and/or geographic features; and

6. Login options for customized views of individual and group defined Geomark data sets.

In the present invention, the geomemory system may include several databases, database tables, GIS, data interchange mechanisms and the required hardware for supporting these databases. Components include a Geomark database(s)/table(s) with a primary key comprised of preferably one or more of the following fields: User Identification, Universal Time measure, geographic position and user annotation. The system also manages the retrieval and display of relevant information available via the Internet. Various statistical processes will be initiated by the user on the Geomark database to retrieve spatial-temporal profiling information. Statistical algorithms may also be used to for this purpose. The inventive system may also contain or interface with various messaging servers (e.g. email, SMS, Voice, Instant Messaging, paging) so that users can receive notification about changes in the geomemory system data as related to desired spatial-temporal co-ordinates. Intelligent software agents initiated by geomemory software clients or via the geomemory Web will be able use the Geomark database to retrieve recommendations regarding locations.

In the present invention, client side devices and software will be provided to help manage the transfer of Geomarks to the Web server and to customize the retrieval and management of stored Geomarks. A number of client side access devices/mechanisms may be utilized by the user to provide and access the Geomarks. Some exemplary devices/mechanisms include:

1. Telematics-capable phone, which can determine a current location and send this information on demand to the geomemory system. This is facilitated by the mobile phone telematics protocol;

2. Telematics-capable PDAs, which can determine a current location and send this information on demand to the geomemory system;

3. Data transferred from wireless location services software that resides in an operator's network. Such software works with a variety of networks including GSM, IS-41 and wireless standards such as AMPS, GSM, CDMA, TDMA, PDC and any other future networks;

4. Using WAP to connect to the geomemory Web site and inputting data manually;

5. Using a PC to connect to the geomemory Web site and inputting data manually;

6. Connecting via voice to the geomemory call center and verbally transferring location information and if desired other Geomark information;

7. The sending of SMS messages in the form of Geomarks;

8. Sending messages from a laptop, PDA or other portable computation device that contains location information, to a LAN or WAN connected to the internet via any method of data transfer including infrared, bluetooth, WAP, cable and or Ethernet card;

9. Extraction and labeling of important Geomarks from location data streamed to the geomemory system;

10. Vehicle based location systems where Geomarks can be stored and downloaded or transmitted; and other similar devices/mechanisms.

In one embodiment of the present invention, client-side transfer management software can reside on such aforementioned devices, such as the telematics-capable phones, telematics-capable PDAs and other devices using GPS to store and forward positional data. In another embodiment, PDA's, PC's and phones that store Geomarks for later downloading to the system, users client-side facilities can transfer management software-code. Data transferred from wireless location services software and hardware that resides in an operator's network, will use software-code to ensure the smooth transfer of Geomarks to the system. Various client software tools will allow for the linking of relevant Geomarks from the system to an individual's personal information management tool or corporate groupware (e.g. Microsoft outlook). The client software will also help incorporate the spatial-temporal based information into client Intranets and groupware. An individual, for example, could store Geomarks and related information for an upcoming trip, using such software.

Referring back to the aforementioned description of the system Web site, a number of different arrangements or partitions for the Web site may be provided, such by providing separate sections dedicated to individual, groups and/or communities. An individual user focused area may contain the following exemplary components/options:

1. A customizable default display of the user's Geomarks. This default display will open with a series of spatial-temporal information bands. For example, a profile of an individual's residential (home) area, recent highly ranked personal Geomarks and data about a place to be visited in the near future. (e.g. Statistics and updates about Hawaii in two months time). The default user page can also be modified to deal with a variety of alternatives including places associated with a current project;

2. Geomark editing tools so that the user can perform tasks such as improving the spatial accuracy of a Geomark, commenting on a Geomark or linking extra information, such as audio, photographic or video information to a particular Geomark. Most importantly the editing tools allow users to define the degree to which information contained in a personal Geomark is private;

3. Tools, or links to tools for updating personal, group or community Geomark data;

4. Subscription options, or links to subscription options regarding updates to changes in the Geomarks or GIS databases related to a particular spatial-temporal area. These updates can be received via SMS, Web-browsing, wireless Internet, email and voice mail to a mobile phone;

5. Tools, or links for obtaining profiles about a particular location based on a mixture of GIS and user generated Geomark content;

6. Tools or links to manual tools for updating personal, group or community Geomark data;

7. A search engine allowing users to obtain spatial-temporal information linked to individuals, groups or communities, or places by keyword and/or geographic features;

8. Information about geomemory friends or pals new Geomarks and when possible their current location;

9. Tools for individuals to share Geomarks with friends/buddies; and

10. Links to intelligent software agent tools that provide users with various recommendations based on analysis of stored Geomarks.

A group-focused area may contain the following exemplary components/options:

1. A customizable default display of the group Geomarks. This default display will open with a series of spatial-temporal information bands;

2. Geomark editing tools so that users can perform tasks such as improving the spatial accuracy of a Geomark, commenting on a Geomark, or linking extra information to a particular Geomark. Most importantly the editing tools allow the group to define the degree to which information stored, as group Geomarks, are private;

3. Links to tools for integrating the geomemory system with various groupware and computer supported collaborative work products;

4. Tools, or links to tools for updating personal, group or community Geomark data;

5. Subscription options, or links to subscription options regarding updates to changes in the Geomarks or GIS databases related to a particular spatial-temporal area. These updates can be received via SMS, Web-browsing, wireless Internet, email and voice mail to a mobile phone;

6. Tools, or links for obtaining profiles about a particular spatial-temporal location based on a mixture of GIS and user generated Geomark content; and

7. A search engine allowing users to obtain information spatial-temporal information linked to individuals, groups or communities, or places by keyword and geographic features.

A community-focused area may contain the following exemplary components/options:

1. A customizable, default-display of a geographical area's Geomark profile linked in with GIS data;

2. A geographically based electronic business card (visiting card) search and exchange tool;

3. Geomark editing tools so that users can make details about themselves available to others;

4. Links to tools for integrating the geomemory system with various groupware and computer supported collaborative work products;

5. Tools, or links to tools for updating personal, group or community Geomark data;

6. Subscription options, or links to subscription options regarding updates to changes in the Geomarks or GIS databases related to a particular spatial-temporal area. These updates can be received via SMS, Web-browsing, wireless Internet, email and voice mail to a mobile phone;

7. Tools, or links for obtaining profiles about a particular spatial-temporal location based on a mixture of GIS and user generated Geomark content; and

8. A search engine allowing users to obtain information spatial-temporal information linked to individuals, groups or communities, or places by keyword and geographic features.

In the present invention, it is contemplated that additional services may be offered by the system such as personalized geographic memory, or personal Web pages where users can retrieve information at a later date about geographical places visited according to standard and spatial-temporal searches. Public or limited access areas or Web pages may be provided which allow individuals to leave spatial-temporal messages on the system for other users to retrieve. Users may be allowed to produce and retrieve spatial-temporal reviews and users may also be able to search for individuals and businesses in a geographic area according to their stated interests. Profiles of visitors to a particular places may also be made available to users. Subscription to broadcast services regarding geographic places, e.g. email list notification about individuals' Geomarking a particular place/area/locality may also be provided in accordance with the present invention.

It will be apparent to those skilled in the art that many changes and substitutions can be made to the system and method described herein without departing from the spirit and scope of the invention as defined by the appended claims. For example, user annotations may be used for structured task management and other related applications.

I claim:

1. A method for providing access to spatial-temporal based information, the method comprising:
receiving a plurality of spatial-temporal based information entries from a plurality of users utilizing geographic positioning compatible devices;
storing the plurality of spatial-temporal based information entries from the plurality of users; and
providing access to the plurality of stored spatial-temporal based information entries, wherein each spatial-temporal based information entry identifies at least one location, a date/time the at least one location was visited and some user annotated information related to the at least one location.

2. The method of claim 1, wherein the user annotation is a voice annotation.

3. The method of claim 1, wherein the at least one location identification includes geographical positioning information and a location name.

4. A method for facilitating global information access, the method comprising:
providing at least one database of spatial-temporal based information, wherein the database is coupled to at least one geographic information system database;
receiving a plurality of spatial-temporal information entries from a plurality of remote user global positioning enabled devices; and
updating the database of spatial-temporal information with the received spatial-temporal information entries, wherein each of the spatial-temporal entries is comprised of a user identification, geographic location, a time and a user annotation.

5. A spatial temporal information access device for providing and accessing spatial-temporal information, comprising:
a spatial-temporal component for providing spatial and temporal information related to one or more locations;
a user interface component for providing and accessing user annotations related to the one or more locations; and
a communications component, wherein the transfer component can send and receive spatial temporal information.

6. A method for receiving and providing spatial-temporal information via a distributed network, the method comprising:
receiving a plurality of geographical bookmarks from one or more remote users;
compiling the plurality of geographical bookmarks in one or more databases accessible by the one or more remote users; and
providing user access to the plurality of geographical bookmarks, wherein each of the geographical bookmarks comprises a destination profile, the destination profile including an annotated description of the destination by the one or more remote users.

7. The method of claim 6, wherein the destination profile includes location and time coordinates.

8. The method of claim 6, wherein the annotated description is a user voice annotation.

9. A spatial-temporal information system, comprising:
a global positioning component;
a geographical information component; and
at least one spatial-temporal component for receiving and storing spatial-temporal information in concert with information received from the global positioning component and the geographical information component, wherein the at least one spatial-temporal component includes a database operative to receive, store and provide access to a plurality of user provided spatial-temporal bookmarks which identify particular locations and descriptive annotated information related to the particular locations, the at least one spatial-temporal component accessible from a plurality of remote locations.

10. The system of claim 9, wherein the descriptive annotated information is speech based.

11. The system of claim 10, further comprising a plurality of global positioning user devices.

12. A method for accessing a dynamic spatial-temporal bookmarking system, the method comprising:
receiving inputs from a plurality of distributed users, the inputs comprising spatial-temporal information entries having user supplied annotations;
aggregating the inputs in a manner to allow for distributed access to the inputs; and
allowing access to the inputs, wherein a user can access a historical collection of the spatial-temporal information.

13. The method of claim 12, wherein the spatial-temporal information is a geographical bookmark having a voice annotation.

14. A method comprising:
receiving destination profile information related to a plurality of users visited destinations;
storing the destination profile information in a database accessible by the plurality of users; and
providing user access to the destination profile information, wherein the destination profile information has at least a location component, a date/time component and a user annotated component which describes the user visited destination.

15. The method of claim 14, wherein the user annotated component is speech based.

16. A method for facilitating rapid spatial-temporal based information collection and access, the method comprising:
providing a simplified user interface for capturing a plurality of spatial-temporal based information entries;
receiving spatial-temporal based information entries via the user interface; and
assembling the spatial-temporal based information for access, wherein the spatial-temporal based information entries contain user annotations.

17. A system for sharing spatial-temporal information via the Internet, comprising:
one or more geographical information system databases;
one or more databases for storing a plurality of geographical bookmarks; and
a Web server in communication with the one or more geographical information system databases and the one or more databases for storing the plurality of geographical bookmarks, wherein the Web server includes a geographical bookmark user interface for receiving spatial-temporal information from at least one user and for presenting information to the at least one user, wherein the information received and presented includes a user annotated portion.

18. The system of claim 17, wherein the user interface is accessed via a plurality of geographic positioning enabled devices.

19. An apparatus communicatively coupling a plurality of clients to a spatial-temporal based information system, the apparatus comprising:
a storage device, operative to store and retrieve spatial-temporal based information on demand; and
a controller, coupled to the storage device, operative to receive spatial-temporal based information from the plurality of clients and on behalf of and in response to client requests, to provide the requesting clients with the received information.

20. A method for enabling sharing and access to a historical collection of location based information provided by a plurality of users employing geographic positioning enabled devices via a distributed information network, the method comprising:
providing a user accessible database for collecting the location based information from the plurality of users;
receiving a plurality of location based information entries from the plurality of users;
storing the historical collection of location based information from plurality of users;
processing the historical collection of location based information; and
providing access to the historical collection of location based information, wherein each location based information entry includes a user annotation.
